(19) United States
(12) Patent Application Publication
(10) Pub. No.: US 2003/0142934 A1
(43) Pub. Date: Jul. 31, 2003

(54) Endoscopic imaging system

(75) Inventors: Yingtian Pan, Stony Brook, NY (US); Gary K. Fedder, Turtle Creek, PA (US); Huikai Xie, Gainesville, FL (US)

Correspondence Address: Robert D. Kucler, REED SMITH LLP, P.O. Box 488, Pittsburgh, PA, 15230-0488, US

(73) Assignee: Carnegie Mellon University and University of Pittsburgh

(21) Appl. No.: 10/316,404

(22) Filed: Dec. 10, 2002

Related U.S. Application Data
(60) Provisional application No. 60/338,964, filed on Dec. 10, 2001.
(60) Provisional application No. 60/339,213, filed on Dec. 10, 2001.

(51) Int. Cl. G02B 6/06

(52) U.S. Cl. 385/116

(57) ABSTRACT

A system and method for an endoscopic optical coherence tomography (OCT) system based on a CMOS-MEMS mirror to facilitate lateral light scanning. The laser scanning scope, adapted to the instrument channel of a commercially-available endoscopic sheath, allows for the real-time cross-sectional imaging of living biological tissue via direct endoscopic visual guidance. A conventional rod lens imaging system may be used for the visual guidance. The MEMS mirror is preferably actuated using either or both of a thermal-mechanical or electrostatic actuation system. More than one MEMS micromirror may be used in a single system for 3D imaging.

### CLAIM OF PRIORITY

This application claims the benefit under 35 U.S.C. § 119(e) of the earlier filing dates of U.S. Provisional Patent Application Serial No. 60/338,964 filed on Dec. 10, 2001 and U.S. Provisional Patent Application Serial No. 60/339,213 filed on Dec. 10, 2001.

### STATEMENT OF GOVERNMENT INTEREST

This application is supported in part by DARPA under the AFRL, Air Force Material Command, USAF, under agreement F30602-97-20323, NIH contract NIH-1-R01-DK059265-01, and the Whitaker Foundation contract 00-0149.

### BACKGROUND OF THE INVENTION

1. Field of the Invention

The present invention relates to laser scanning imaging systems, and, more particularly, the present invention relates to employing optical coherence tomography in a conventional endoscope utilizing one or more MEMS devices.

2. Description of the Background

Optical Coherence Tomography (OCT) is an optical imaging technique that permits high resolution cross-sectional imaging of highly scattering media. OCT is based on optical coherence domain reflectometry (OCDR—originally used to inspect fiber optic cables for defects), which utilizes broadband light and interferometry to detect the pathlength distribution of echoes of light from reflective interfaces. Two-dimensional and three-dimensional images can be obtained by combining OCDR measurements (i.e., longitudinal scans) with sequential transverse scans.

Generally speaking, OCT combines the principles of ultrasound with the imaging performance and techniques of a microscope. Ultrasound produces images from backscattered sound echoes, and OCT uses infrared light waves that reflect off the internal microstructure within the biological tissues. These light reflections are then used to image the specimen. The frequencies and bandwidths of infrared light are orders of magnitude higher than medical ultrasound signals which results in greatly increased image resolution when compared to any existing modality.

Infrared light for OCT is typically delivered to the imaging site through a single optical fiber which may be only a fraction of a millimeter (mm) in diameter. The imaging guidewire contains a complete lens assembly to perform a variety of imaging functions. Because of its size, OCT imaging can be performed over approximately the same area as a biopsy at high resolution and in real-time. Thus, the most attractive applications for OCT are those in which conventional biopsies cannot be performed or are ineffective, or where non-invasive or minimally invasive procedures are preferred.

Ultrasonic echoes travel at the speed of sound and can therefore be manipulated using conventional computing techniques. However, because of the extremely high velocity of light, interferometric techniques are required to extract the reflected optical signals from the infrared light used in OCT. The output, measured by an interferometer, is computer-processed to produce high resolution, real-time, cross-sectional or 3-dimensional (3D) images of the specimen tissue. This technology provides in situ images of tissues at near histological resolution without the need for excision or processing of the specimen.

Since its first introduction to imaging the transparent and low-scattering tissues of eyes, OCT has become attractive for other non-invasive medical imaging. OCT has also been used to image a wide variety of biological tissues such as skin, tooth, gastrointestinal tracts, genitourinary tracts, and malformations thereof.

Recent technological advances include near real-time or real-time OCT, ultra-high resolution subcellular OCT, dual wavelength and spectral OCT, polarization OCT, and Doppler OCT which are used to provide enhanced image contrast and diagnostic specificity. Further, experiments have demonstrated that the internal morphological and cellular structures in biological tissues can be displayed by the spatially resolved map of the reflected light in an OCT image with high spatial resolution (e.g., 10 μm) and sensitivity (e.g., >100 dB).

In order to provide the additional transverse scans for 2D and 3D imaging, several techniques have been proposed. For example, endoscopic OCT devices for in vivo imaging of internal organs have also been speculated in which transverse scanning is performed either by a rotary fiber optic joint connected to a 90° deflecting microprism (in a circumferential pattern) or by a small galvanometric plate swinging the distal fiber tip (in a line-scan pattern). The rotary fiber joint method is side view only (not front view OCT) and includes no imaging guidance. The swinging method is fragile, slow, and makes it difficult to maintain high quality light scanning. Because of limitations and complications in these previous attempts, development of high performance, reliable and low-cost OCT catheters and endoscopes suitable for future clinical applications still remains desirable.

### SUMMARY OF THE INVENTION

In at least one preferred embodiment, the present invention provides an endoscopic imaging system that uses a microelectromechanical system (MEMS) chip to achieve high speed transverse light scanning imaging (e.g., OCT) in a slender endoscopic tube, while maintaining high light coupling efficiency and spatial resolution. MEMS preferably facilitates endoscopic beam steering because of its small size, low cost, and excellent micro-beam manipulating capacity.

Specifically, the present invention comprises one or more micromachined MEMS mirrors to scan internal living features, via an endoscope tube. For example, an existing cystoscope provides a 5 mm instrument channel which allows for a large lateral OCT scan. However, the invention may also be used with smaller scopes, such as a 2-3 mm scope.

The mirror is preferably actuated via either a thermal-mechanical or an electrostatic actuation scheme. In the thermal-mechanical case, the MEMS mirror is disposed on the end of a cantilever made of at least two materials (bi-material). The coefficient of expansion of each of the materials is different, and heat is applied to the cantilever via current flowing through an embedded resistor. This heat causes the two materials to expand (or contract) at different rates thereby causing the cantilever (and, hence, the mirror) to bend and straighten under the control of the applied current.

In the electrostatic case, the MEMS mirror is disposed on a torsional beam made of single-crystalline silicon. Two “finger” electrodes are placed as part of the optical system. A first electrode is fixed below (or above) the mirror, and a second electrode is disposed on the side of the mirror assembly. The finger electrodes are preferably interdigitated to provide a vehicle for applying a voltage therebetween. When the voltage is thus applied, the two electrodes are attracted in such a way as to rotate the mirror into and out of plane against the torsional beam. Again, the mirror can be controlled in a bi-directional manner under precise control.

In some optional embodiments, one or more of the above or a different control mechanism are combined to provide control of the MEMS mirror in more than one direction. For example, the mirror may be moved along the plane of the cantilever and may also be rotated 90 degrees to that plane. By providing for more than one axis of control, two- and three-dimensional (2D and 3D) OCT and other scans may be facilitated. More than one MEMS mirror may also be used to facilitate such multiple degree scans.

Further, the components of the optical assembly, as described more fully below, may be arranged in a plurality of orientations to provide for various imaging schemes. For example, if the scanning light beam is reflected off a regular mirror, up to the MEMS mirror, and out the front of the endoscope tube, a front scanning OCT scope is enabled. Alternatively, if only a single MEMS mirror is used (without the regular mirror), the scanning light beam may be oriented perpendicular to the opening of the endoscope tube and a lateral scan is enabled. Variations on this general scheme are contemplated within the knowledge of one skilled in these arts.

The present invention, in its various embodiments, addresses one ore more limitations in prior art endoscopic imaging systems. Other and further objects and advantages of the present invention will be made clear through the following description of the invention, the attached drawings and the claims.

### BRIEF DESCRIPTION OF THE DRAWINGS

For the present invention to be clearly understood and readily practiced, the present invention will be described in conjunction with the following figures, wherein like reference characters designate the same or similar elements, which figures are incorporated into and constitute a part of the specification, wherein:

FIG. 1 is a general diagram of the main system components of an endoscopic OCT system according to the present invention;

FIG. 2 a detailed diagram of the main system components of an endoscopic OCT system according to the present invention;

FIG. 3 shows the profile of a typical 22Fr endoscope instrument sheath;

FIG. 4 details a preferred optical component arrangement according to the present invention;

FIG. 5 shows an exemplary OCT scan of two microscope slides;

FIG. 6 shows an additional exemplary OCT scan of a bladder;

FIG. 7 shows a top (7(A)) and side (7(B)) view of a thermal-mechanical MEMS mirror control system;

FIG. 8 shows an isometric view of the electrostatic MEMS mirror control system;

FIG. 9 details the present invention used with a polarization beam splitter;

FIG. 10 depicts a lateral scanning optical system with a single MEMS mirror; and

FIG. 11 depicts an optical system with two MEMS mirrors.

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, other elements that may be well known. Those of ordinary skill in the art will recognize that other elements are desirable and/or required in order to implement the present invention. However, because such elements are well known in the art, and because they do not facilitate a better understanding of the present invention, a discussion of such elements is not provided herein. The detailed description will be provided hereinbelow with reference to the attached drawings.

The present invention preferably incorporates optical coherence tomography (OCT), or other laser scanning imaging modalities, into a slim endoscope instrument channel. Although many applications of OCT are known, the ability to control the scanning of the light source in an extremely narrow instrument channel is not easily facilitated using conventional technologies. As such, novel ways to control such scanning are provided by the present invention. Although the figures show general system diagrams of several alternative embodiments of the present invention, many other and further embodiments will be understood to those skilled in the art (e.g., using a catheter rather than an endoscope) based on these depicted embodiments.

The general functionality of an OCT system is based on the ability to direct a light source over a distance to scan an area of a specimen. This scanning operation is facilitated by using one or more rotatable or translatable mirrors that can be manipulated to move the light beam. When designing such a mirror, there are at least three major mirror attributes that must be balanced in order to ensure proper OCT operation. Those mirror requirements include: (1) the size of the mirror; (2) the scanning angle of the mirror; and (3) the response time of mirror movement. The general problem with these systems is designing lateral scanning ability into a very confined space: the endoscopic tube. A specialized MEMS mirror is capable of satisfying these requirements by allowing for a large beam size in a confined space.

In order to have a sharp focus in the received image, a large beam size and a very small focal distance for the scanning light beam is necessary. Without a substantial beam size, an acceptable focal spot, which determines the lateral resolution of the microscope design, can not be achieved for a practical focal distance in endoscopic settings. The present invention incorporates a larger mirror than conventional applications to create an adequate beam size which can be used for OCT or other laser scanning technologies such as Confocal Endoscopy or Multi-Photon Excitation Endoscopy. For example, in fiber optic switching applications as briefly described above, MEMS mirrors are generally on the order of about 300 microns or less. For the present application, the mirror may be 1 mm×1 mm, or even larger.

In addition to mirror size, precise mirror movement is also crucial for scanning applications. For a large scanning angle and a quick response time, there are at least two types of control systems for the MEMS mirror: (1) a thermal-mechanical design and (2) an electrostatic design. The thermal-mechanical design gives a very large scan angle (up to 18 degrees or more), but the speed may be limited by thermal relaxation. The electrostatic design generally provides faster speed and lower power consumption compared to the thermal-mechanical design; however, the scan angle in the electrostatic design may not be as large as in the thermal-mechanical application. Hence, although both systems are improvements over the conventional designs, one or the other may be better suited to a particular application depending on the desired characteristics.

It should also be noted here that the present invention allows for conventional surface imaging (including but not limited to diagnostic fluorescence endoscopic imaging) and cross-sectional imaging to be performed simultaneously. Physicians and other operators will therefore get a more complete view of the specimen tissue (combining both physiological and micro-morphological features) through the use of the present invention.

The following detailed description of certain embodiments is based on the present invention being incorporated into a conventional endoscope. However, the present invention may be used with a wide variety of endoscopes or other instruments, such as a bronchial scope for the esophagus, an osteoscope for orthopedics and various other scopes for cervical or colon cancer and the kidneys. For all of these various designs, the general design is the same.

A description of the main system diagram is now provided to illustrate the overall functioning of the system. As briefly described above, OCT is based on microscopic interferometry—light interferometry illuminated with broadband light. The present invention combines OCDR a technology originally used to inspect fiber optic cable to look for defects—with a lateral scanning mirror design. With OCDR, a one-dimensional or “Z-direction” scan is achieved. With the addition of the lateral scanning mirror, a two-dimensional scan, with two mirrors, a three-dimensional scan is achieved.

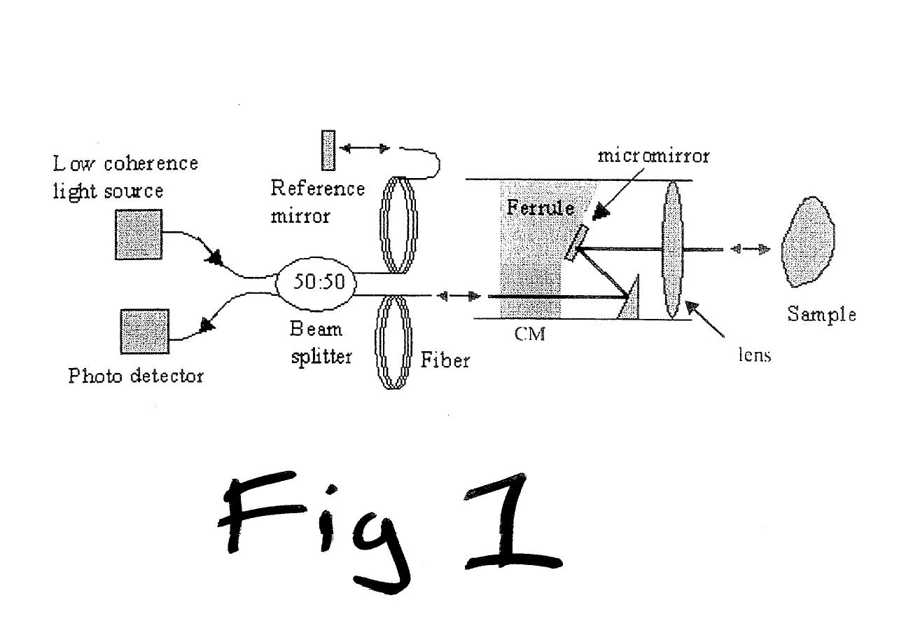

FIG. 1 is a generalized system block diagram showing the main components of the present system. FIG. 1 illustrates a 5 mm diameter endoscopic OCT system equipped with a single MEMS micromirror. A broadband (low coherence) light source is guided equally into two single mode fibers through a 50:50 beam splitter to form a Michelson interferometer. The light in the sample arm (lower arm) is collimated by a fiber optic aspherical lens CM, and deflected by a conventional mirror and the beam steering MEMS micromirror. The beam is then focused through a lens (e.g., an achromatic lens or, in some embodiments, a GRIN lens) on the detecting biological sample which reflects part of the incident light back to the sample arm. The light in the reference arm (upper arm) is linearly scanned in the axial direction by an optical delay line. A photo detector represents the system for analyzing the reflected scan beam to product an image of the specimen. Because broadband light has short temporal coherence, this orientation permits detection of backscattering from different depths within the sample.

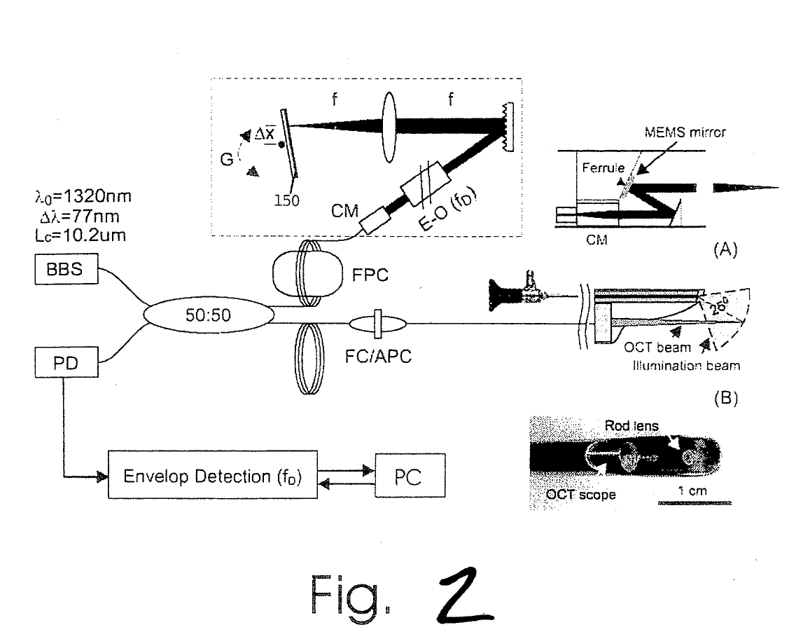

A more detailed description of the system will now be given with reference to FIG. 2. FIG. 2 details the main components of one embodiment of the present invention in greater detail (and includes exploded diagram of the scan head in FIG. 2(A) and a picture of the OCT and rod lens scope in an endoscope sheet in FIG. 2(B)). A broadband light source BBS is initially provided with defined light spectral characteristics and is coupled into a fiber optic Michelson interferometer. The source BBS is preferably a standard commercial broadband light source, and the spectral specifications are typically defined by the commercial entity that provides the light source For example, the pigtailed output power P of the light source BBS may be 12 mW, the central wavelength λ₀=1320 nm, the FWHM spectral bandwidth Δλ=77 nm, and coherence length L_{c}=10.2 μm.

The light beam from source BBS is then sent through a beam splitter, for example the 50:50 beam splitter shown in FIG. 2 which separates the light from the light source BBS into two equivalent (½ power) light beams. In practice, the beam splitter may be a fiber coupler, or more specifically, it may be a single mode fiber optic coupler serving as a beam splitter. These two light source beams are used for scanning the specimen (lower arm) and for providing a reference signal (upper arm) with which the scanning signal can be compared for imaging.

After the input light beam BBS is equally divided into the two arms of the Michelson interferometer (50%:50%), in the reference arm of the fiber optic interferometer, a fiber polarization controller FPC is used to ensure that the polarization of light exiting the non-PM fiber (SMF-28) is almost linearly polarized. The FPC has three disks that may be manipulated to adjust the polarization of light passing therethrough. Therefore, a polarized beam of light exits from the fiber in the reference arm.

The object of the reference arm of the present invention is to have the light beam hit the reference mirror 150 at an offset ΔX. The light beam must hit the mirror 150 at an offset ΔX from the center of the mirror to create a Doppler shift in the beam. The ΔX offset can be used for a Doppler shift or an optical phase shift of the beam. One potential problem with this orientation is that to obtain a desirable Doppler shift, a mirror that is too large to be desirable is needed because the phase shift of the Doppler frequency is proportional to the offset ΔX (i.e., larger mirror=larger offset=larger Doppler shift). In order to achieve a desirable Doppler shift for demodulation, therefore, a large offset ΔX (and hence, a large mirror 150) is needed. However, a large mirror cannot typically be used in this type of device orientation because the large mirror “wobbles”. This wobbling causes a deflection of the light beam and will disrupt the scanning coming off of the mirror 150.

To address this limitation, the offset ΔX is preferably removed from the design of the system. ΔX is set to zero, and the reference arm light beam is directed to strike the center of the reference mirror 150. The desired Doppler shift is separately created by passing the reference light beam through an electro-optical phase shifter E-O, also called an electro-optical phase modulator. The phase modulator E-O can create the Doppler phase shift, and the reference mirror 150 itself will give the axial delay line. In short, the delay line gives the optical delay and the phase modulator or phase shifter E-O gives the Doppler effect or Doppler delay (or, alternatively, a differential acoustic modulator could be used for the same purpose). In this way, the optical delay is separated from the Doppler shift. Alternatively, optical heterodyne detection can also be located in the phase modulator in order to manage the Doppler shift or Doppler effect.

Although the above reference arm may be realized in various ways, one exemplary system will be described in more detail. In this example, the light from the FPC is coupled into a Φ2 mm collimated beam by an angle-polished GRIN lens CM and then guided to a high speed depth scanning unit containing an electro-optical phase modulator E-O and a rapid-scanning grating lens-based optical delay line to implement OCT imaging in real time. The principle of a grating lens-based optical delay line as described above is known in the art. The temporal profile of a broadband light is linearly distributed at the Fourier focal plane of a grating lens pair; thus, placing a mirror at the focal plane and tilting it rapidly with a galvanometer allows fast group delay. Furthermore, this method permits phase and group delays to be independently managed.

In conventional arrangements, the light phase shift is controlled by adjusting offset ΔX of the tilting mirror which results in increased mirror size and in turn a restriction on the speed of depth scanning. The present invention's centering of the galvo mirror (ΔX=0) with an electro-optic phase modulator E-O inserted to generate a higher and more stable Doppler frequency shift for heterodyne detection solves these problems. By selecting each component (e.g., f=80 mm/Φ35 mm for the scan lens, g=450 lines/mm for the diffraction grating, 4 mm VM500 galvanometric mirror tilted at 4.2° and with 1.2 kHz repetition rate, and 2.4 MHz resonant E-O phase modulation), the high speed depth scanner allows the acquisition of 2.4K axial scans per second with an optical delay window of 2.8 mm (higher pathlength delay is possible by increasing the tilting angle).

The high and stable Doppler frequency shift results in an increased signal to noise performance of the signal processing electronics. Moreover, the dispersion induced by unbalanced fiber lengths and optical components between the two arms of the Michelson interferometer can be minimized by slightly moving the grating along the optical axis, which can greatly enhance the axial resolution as has been observed during the alignment.

There are at least two ways that the present use of the E-O may be an improvement over the prior art. The first is to use a Differential Acoustic Optical Modulator. For this component, the frequency of a laser is modulated to achieve a 2 MHz round trip Doppler shift (e.g., two A-O modulators can be set at 55 MHz and 54 MHz). The second improvement method uses a broadband Electro-Optical Modulator. This broadband version is driven by a triangle wave, and a single Doppler frequency results. In the first alternative, multiple Doppler frequencies may be achieved because of all the base functions, but certain embodiments also allow for a single resulting Doppler frequency. When a single Doppler frequency ensues from either alternative, a higher quality result with better signal-to-noise ratio is typically achieved.

The fiber end in the sample arm (lower arm) of the interferometer is connected to a pigtailed OCT scope through a modified FC/APC connector (FC/APC), which can be inserted into, for example, the φ4 mm instrument channel of a 22Fr endoscope. The FC/APC terminator is a standard coupler or terminator used for fiber optic communication. However, in a preferred embodiment of the present invention, only the ferrule of the FC/APC connector, which is approximately 2.5 mm in diameter, is used. Because the ferrule is only 2.5 mm, it can be inserted into a standard 4 mm instrument channel on an endoscope. Because the lateral scanning range is determined by the size of the OCT tube, a large scale scope is preferred (in order to achieve a larger OCT imaging range per scan).

A preferred scope by itself is approximately 5 mm in diameter. The entire ferrule of the standard FC/APC is preferably inserted “back” into the front side of the endoscope. The ferrule is inserted from the front side rather than the back side, and the ferrule is then glued or screwed into the instrument channel. In conventional endoscope applications, the scope is first inserted into the patient, and thereafter the instrument is inserted from the back of the tube (outside the patient). In the present invention, the instrument comes in the front way before the operation and then the FC/APC and the two wires are fixed inside the scope with silicon or other adhesive. Various alternatives of this preferred embodiment are also envisioned.

A conventional rod lens system is then inserted into the endoscope and used for illumination and for surface imaging. In this way the operator can view both the surface of the specimen (via the rod lens system) as well as the interior region of the specimen (via the OCT). The preferred rod lens system operates in real-time and returns about 30 frames per second. Preferably the rod lens system is incorporated into a small size endoscope—for example a 2.7 mm pediatric hysteresis scope. In conventional applications, a large size scope is used for better illumination and larger pixel size (better image fidelity), but the present invention is not based on the surface imaging. Therefore, a smaller pediatric scope is used and inserted into the larger 22Fr scope along with the OCT system. The smaller surface imaging endoscope allows for maximum clearance for the OCT.

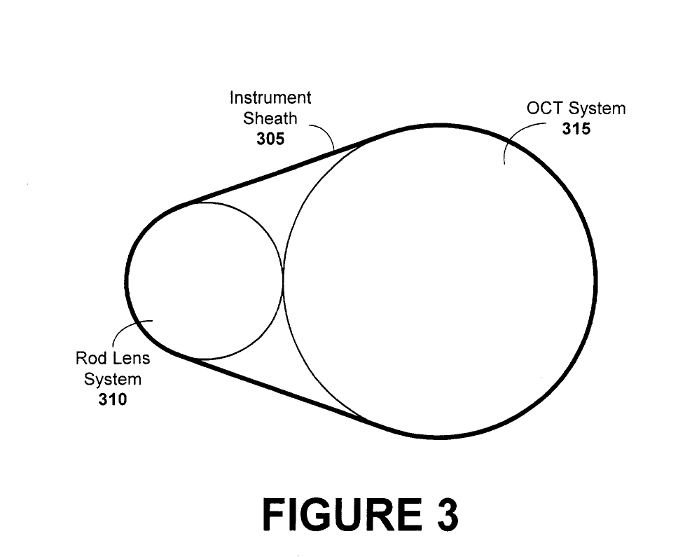

FIG. 3 shows the profile of a typical 22Fr instrument sheath 305 as used according to the present invention. As seen in FIG. 3, a conventional instrument sheath 305 is not round, but is actually a modified symmetric oval shape. Therefore, in one of the small corners of the oval, the 2.8 mm pediatric scope 310 (or other small scope) is inserted, leaving the remainder of the space within the instrument sheath 305 in which the largest OCT 315 that can be fit is thereafter inserted. In other words, the rod lens system 310 and the sheath 305 are both standard materials, but they are used in the present invention in a non-standard way to accommodate both a smaller pediatric scope 310 and a larger OCT system 315.

Looking at the lower part of FIG. 2, the signal processing elements and other common imaging elements are shown. Generally speaking, an interference signal is bandpass filtered using a Doppler frequency shift. This component orientation is known as Optical Heterodyne Detection and provides a signal over a 100 dB dynamic range. This signal is actually transferred to a very high speed analog to digital converter (A/D). The signal is then sent to a computer PC, and the computer is used to display the two-dimensional (or three-dimensional) image. Preferably, the computer can display the image in almost real-time, at approximately 5 frames per second, or higher.

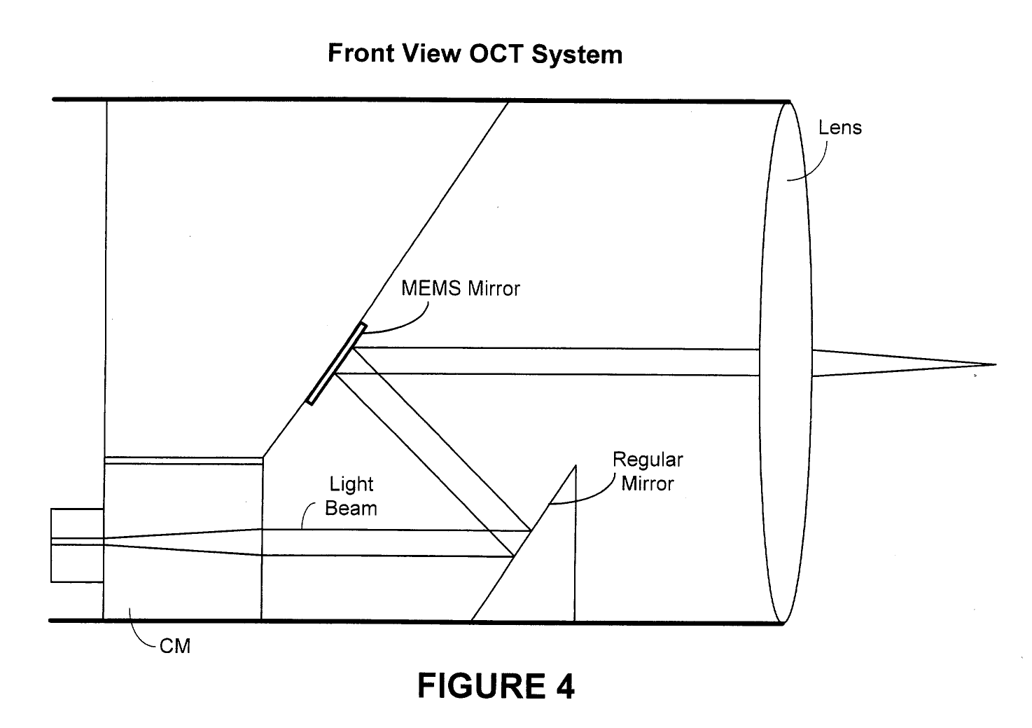

The right half of FIG. 2 depicts one preferred optical arrangement for a distal OCT scope, and FIG. 4 includes an expanded view of this preferred optical arrangement. The light from the fiber is coupled by a 0.25-pitch selfoc lens to a φ0.8 mm collimated beam, deflected by a pair of mirrors and then focused by a laser doublet (f10 mm/φ5 mm) to a roughly φ20 μm spot size on the image plane. The transverse light scanning in the OCT scope is facilitated by an Al-coated CMOS-MEMS planar mirror as described below.

The MEMS mirror is preferably fabricated by a CMOS micromachining process. Because of technical limitations, large, flat MEMS mirrors with large tunable displacement or rotation angle required for fast laser beam steering which may have widespread applications in laser scanning endoscopy and other medical imaging techniques have traditionally been difficult to achieve. The large 1 mm×1 mm MEMS mirror used in exemplary embodiments of the present invention is a single-crystalline silicon chip fabricated by using a deep reactive ion etch (RIE) CMOS-MEMS process to ensure large actuation range and optical grade flatness.

The MEMS mirror may be a thermaI-mechanically actuated microscanner whose hinge is a bimorph thermal actuator comprised of a stack of Al (t₁=0.7 μm) and SiO₂ (t₂=1.2 μm) thin films. Because of the residual stress and difference in the thermal expansion coefficients between these two thin layers, the hinge curls up to an initial (e.g., room temperature) bending angle at θ₀≈17° above the chip plane and the bending angle θ changes with the temperature within the bimorph. The embedded polysilicon thermal resistor in the bimorph mesh acts as the heat source to actuate the hinge of the mirror and the relation between the actuation angle θ and the external voltage V can be approximated as:

θ=k(E₁,E₂,t₁,t₂)LΔαΔT∝V² Equation (1)

where k is a coefficient related to the Young's modulus E and the thickness t of the two layers. L is the length of the stacked thin films, Δα is the differential thermal expansion coefficient between Al and SiO₂. The induced temperature difference ΔT is approximated to V² where V is the voltage applied to the MEMS chip. Preliminary test results show that the resistance of the embedded polysilicon heater is 2.2 kΩ. The maximal electrical current or voltage applied to the heater is 15 mA, corresponding to 30V. The resonant frequency of the CMOS-MEMS mirror is 165 Hz, exceeding the speed requirement for most 1-D endoscopic laser scanning applications. According to Equation (1), the electrothermal rotation is proportional to V²; therefore, the scan is nonlinear, and nonlinear correction to the applied voltage is required.

Because of a 17° initial bending angle, the ferrule housing the MEMS mirror has to be tilted to roughly 17°/2 to maintain the reflected beam in the center of the optical axis. The results on a test stage show that the mechanical scan angle is on the order of ±8°, yielding a ±15° optical scan angle for beam steering. The detected interferometric signal is pre-amplified by a low-noise, broadband transimpedance amplifier (Femto HCA-10M-100K), bandpass filtered and demodulated prior to being digitized by a 5 MHz, 12-bit A/D converter. Both depth scan and lateral MEMS scans are synchronized with the image data acquisition via 2 16-bit D/A channels.

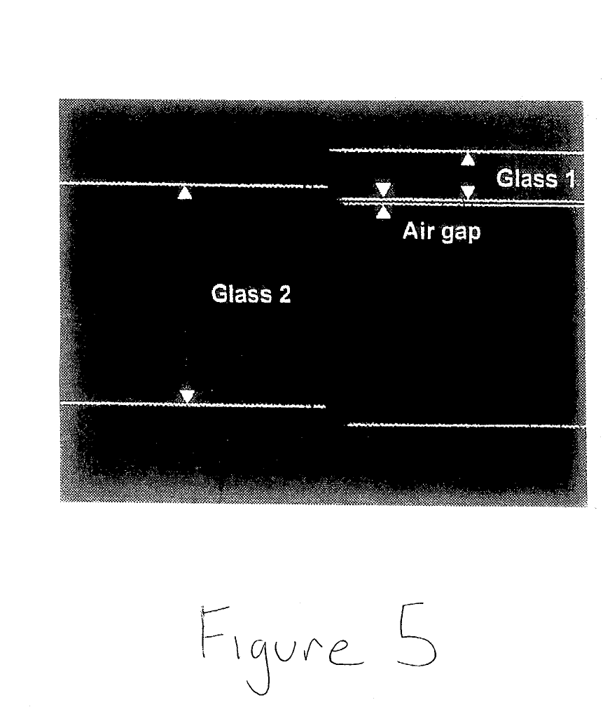

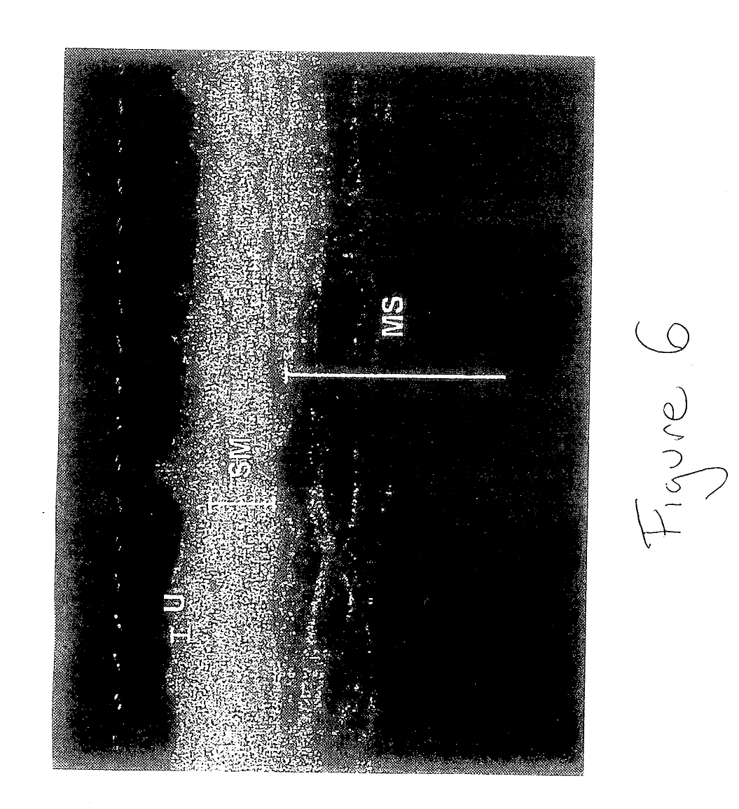

Several examples of images that may be captured using the present invention are depicted in FIGS. 5 and 6. In FIG. 5, a glass slide is shown to depict the field flatness and biological tissues in vivo to show the image fidelity. FIG. 5 is an OCT image of the border of a 225 μm thick cover slide stacked on a 1 mm thick glass plate. The 500×1000 pixel cross-section covering an area of 2.9 mm×2.8 mm may be acquired at ˜5 frames/s. The results demonstrate the field flatness of the endoscopic OCT system using a MEMS mirror for light steering in the lateral direction.

FIG. 6 is an OCT image of a porcine urinary bladder in vivo. In FIG. 6, micro-morphological details of the bladder wall, e.g., the urothelium (U) or epithelium, submucosa (SM) and the upper muscularis layer are readily delineated. Because most transitional cell carcinomas originate in the urothelium, these figures indicate the potential of MEMS-based endoscopic OCT for early detection and staging of bladder cancers. Also, as a wide variety of inner organs (e.g., cervix, colon, joints) can be accessed and imaged by front-view endoscopic OCT, the results suggest the potential applications of this technique for noninvasive or minimally invasive imaging diagnosis in these tissues.

MEMS Mirror

As briefly introduced above, one of the problems with prior art systems is the lack of a mirror large enough to impart sufficient scan angle and effective light beam reflection while remaining small enough to fit in a conventional endoscopic tube and be easily manipulated. Because the instrument channel must accommodate both the MEMS mirror laser scanner (for internal imaging) and the rod lens system (for surface imaging and illumination), the maximum size for the MEMS mirror is approximately 1-1.5 mm per side. Therefore, an exemplary mirror used with the present invention is approximately 1 mm×1 mm×25-40 microns. The mirror may be fabricated by a combination of Reactive Ion Etching (RIE) with general CMOS micro-machining as described in U.S. patent application Ser. No. 09/409,570 entitled “Method of Fabricating Micromachined Structures and Devices Formed Therefrom” which is incorporated herein by reference. Although the fabrication of such a mirror is clearly defined in this reference, several pertinent details will be provided for clarity.

The basic structure of the mirror is a single-crystalline silicon (SCS) micromirror using a deep reactive-ion-etch (DRIE) post-CMOS micro-machining process. Numerous micromirrors have been demonstrated by using either surface or bulk micromachining processes. However, micro-machined large, flat mirrors with large tunable displacement or rotation angle required by the present laser scanning invention are not currently available.

In addition to any fabrication difficulties, it is difficult to accurately and rapidly move such mirrors once in place. At least two technologies are presently contemplated for effectively controlling such a mirror: electrostatic and thermal-mechanical control. For the thermal-mechanical control option, the actuation concept of the mirror involves locating a flat mirror on a cantilever, the opposite end of the cantilever being anchored. The cantilever itself is made as a flexure rather than being part of the mirror. This flexure is comprised of a thin film material and is much thinner than the mirror itself. Preferably, the flexure is made out of the top thin film materials of the CMOS fabrication process—preferably made out of glass, silicon dioxide and aluminum and it also has polysilicon (polycrystalline silicon). The actual flexure thickness is on the order of 5 microns instead of 50 microns—approximately 10 times thinner. In some applications, the flexure may even approach 1 micron in thickness.

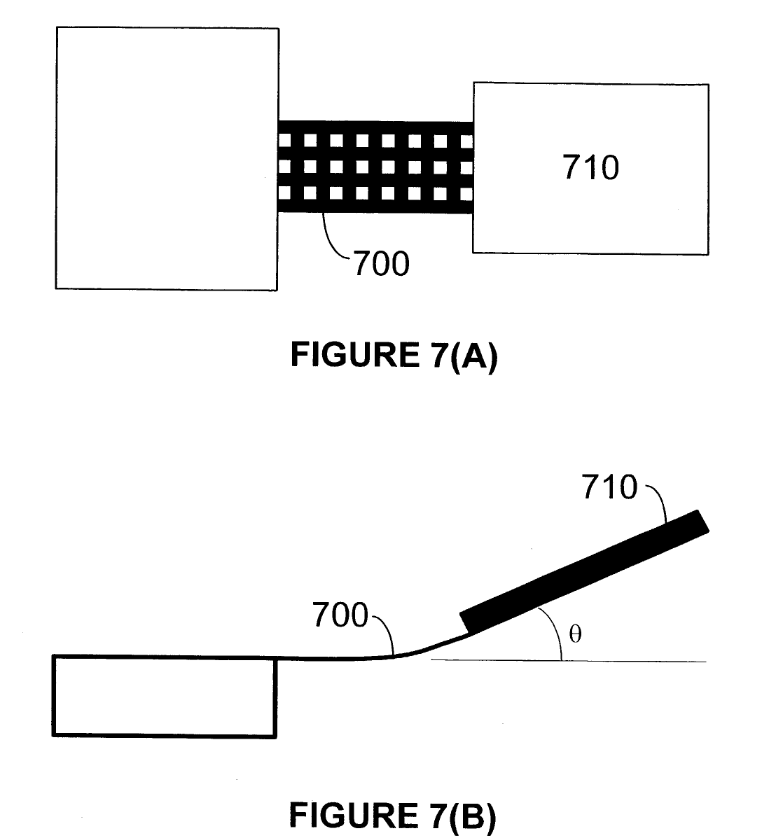

FIG. 7 shows a top (FIG. 7(A)) and side (FIG. 7(B)) view of the flexure 700 with attached mirror 710.

For thermal-mechanical control, the flexure material is a composite, a laminated structure with a glass on one side and a metal on the other. There may actually be a series of metal layers, but from a conceptual point of view, the flexure may be thought of as a bi-material strip, similar to a thermostat. These two materials (e.g., glass and aluminum) have an intrinsic stress within them when deposited on the wafers for the CMOS when the micro-machining is performed. When the mirror is released in the manufacturing process and is free to move, that intrinsic stress is released in the films and the films will try to relax this stress. One of the films (e.g., aluminum) actually pinches in because of residual tensile stress, and the other material (e.g., silicone dioxide in the glass) is typically under compressive stress causing it to expand. When the combination of the expansion and the contraction occurs, the mirror plate 710 tends to arc up (θ) because it is at the end of a cantilever. Therefore, the intrinsic residual stress of the bi-material strip 700 causes the MEMS mirror to be initially out of plane by an amount θ.

When the films are heated to higher temperatures, the temperature coefficient of expansion of the two materials is different in such a way that the aluminum will expand more and the glass will expand less causing the mirror to bend back down toward a flat plane (straightening the cantilever and reducing θ). In all, the bi-material cantilever design allows for a mirror that is bent out of plane at room temperature, and, when the cantilever is heated, bends the mirror down into plane. Therefore, by controlling the temperature of the cantilever, the angle of mirror displacement may be controlled.

Preferably, the heating is performed using a polycrystalline silicon resistor built into the flexure 700 and running current through the flexure during operation, causing the resistor to heat up. Because the flexure has such a small heat capacity, it preferably takes little energy to heat the flexure to several hundreds of degrees Centigrade. In fact, the operator of the system needs to be careful not too impart too much heat to the flexure, which will easily melt and destroy the mirror system.

Testing such an optical system determined that by controlling the temperature between room temperature up to on the order of 100-150 degrees Centigrade, the flexure angle can achieve a displacement angle of approximately 17 degrees in a particular embodiment that is designed to be almost flat. Therefore, the maximum angle for this particular embodiment is on the order of 17 degrees. This type of design is relatively simple to design, gives a reasonably flat mirror, results in a 17 degree scan angle which is adequate for the OCT application, and the mirror is large relative to conventional mirrors with these properties. One potential problem occurs because it is thermally actuated, causing the optical system to be very temperature sensitive which must be isolated from an ambient temperature or close-loop controlled.

Also, because the flexure is used, there is actually an offset when the mirror is tilted through its range of motion. In other words, the tilt θ is coupled with the vertical motion so the optical system must take into account not only the expected angle caused by a current applied to the flexure but also the predicted vertical displacement. Especially in an interferometic imaging application such as OCT, the optical system must closely track this vertical displacement. One major advantage of this optical control system is its robustness—few parts and uncomplicated theoretical operation.

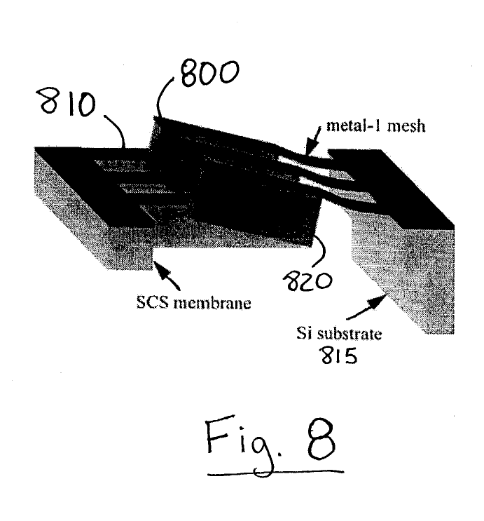

An additional control system for the MEMS mirror involves electrostatically controlling the mirror. Preferably, a similar bulk silicon mirror, such as a 1 mm×1 mm flat mirror, may be used for this application. With electrostatic control, electrostatic attraction between electrodes is used to pull the mirror in one direction or the other (e.g., bend the mirror assembly in and out of plane against a central torsional beam). In this particular design, the actuator elements must be specially designed to get a large stroke—to get a large angle of motion for controlling the mirror. Specifically, electrostatic control systems have traditionally been used to control a mirror with a very small scan angle—on the order of less than one degree of movement. The present invention, as described above, demands a larger scan angle (e.g., +/−5 or +/−10 degrees). For an electrostatic actuator to control a mirror with this large of a movement, the electrodes of the actuator must be positioned such that one electrode is higher than the other in a vertical orientation. In a planar or MEMS process, this is made more difficult because all elements are typically extruded out of a single layer. FIG. 8 shows an isometric view of the electrostatic MEMS mirror control system.

The present invention takes advantage of the “curling” effects at room temperature of the bi-material cantilever described above to impart this same curling effect using an electrostatic control system. The electrodes on the actuators are designed such that one electrode is flat and the other electrode is designed to curl out of plane exploiting these thin film bi-material strips. The two electrodes are then made as interdigitated finger electrodes—like interlocked fingers in two hands, with fingers slightly spread, the two hands being on top of each other. The interdigitation of the two electrodes allows for a voltage between them. If one of the electrodes 800 is placed above the other 810, and a voltage is applied between the electrodes, the voltage will cause the electrodes to pull on each other and flatten the MEMS mirror into a planar arrangement.

In more detail, the electrostatic control system utilizes a CMOS-MEMS mirror with an electrostatic comb drive that can generate large displacements. As in the previous case, the mirror is preferably made of single-crystal silicon (SCS) and is coated with aluminum. The fabrication of the mirror uses a deep reactive-ion-etch (DRIE) CMOS-MEMS process as described above and described in more detail in Xie H., Erdmann L., Zhu X., Gabriel K. and Fedder G. K., 2000, “Post-CMOS processing for high-aspect-ratio integrated silicon microstructures,” Technical Digest: 2000 Solid-State sensor & Actuator Workshop, Hilton Head, S.C., pp. 78-81 which is expressly incorporated by reference herein in its entirety.

As seen in FIG. 8, the metal-1 mesh (beam) has only thin layers of interconnect aluminum and dielectrics. The beam curls up after it is released because of the residual stress and different coefficients of thermal expansion of the embedded materials. Thus, a comb drive with the stationary and movable fingers at different levels—a curled comb drive—can be created. The comb drive has a set of tilted comb-fingers 800 and a set of flat comb-fingers 810. The tilted comb-fingers 800 are comprised of a curled metal-1 mesh and an array of tilted comb-fingers with a thick SCS layer. The silicon substrate 815 below the metal-1 mesh is completely undercut during the deep Si etch and the metal-1 consists of only narrow beams. Therefore, the SCS “chunks” 820 under the tilted comb-fingers are electrically isolated from the silicon substrate 815 and can be wired to any place on the chip (e.g., a bonding pad). When a voltage is applied to the comb drive, the tilted comb-fingers will tend to align with the flat comb-fingers (or vice versa) and thus a rotation is generated. The tilt angle of the curled comb-fingers depends on the length of the metal-1 mesh and can be 45 degrees or even larger. In all, the motion is similar to that described above in the thermal-mechanical situation.

Because the voltages of the present actuation system are very controllable, testing will reveal a correspondence between voltage applied and the actuation angle of the mirror system for any particular material and size selection. Therefore, a voltage can be applied according to the test results to provide a very controllable solution for moving the micromirror.

Further, the thermal-mechanical and the electrostatic actuation systems may be combined (preferably at right angles to each other, to control the mirror in two directions. Control in two directions provides additional functionality to the OCT system as described more fully below. Wherever possible, it is desirable to decouple the various control methodologies of the present invention from each other. Three different voltages, one for a first rotation, one for another rotation and a third for vertical displacement are preferred. The placement and the design of the actuators to achieve a large stroke with a de-coupling of these motions, all using a “reasonable” voltage (e.g., something under the breakdown voltage of the oxide so the actuation device is not destroyed).

Additional Embodiments

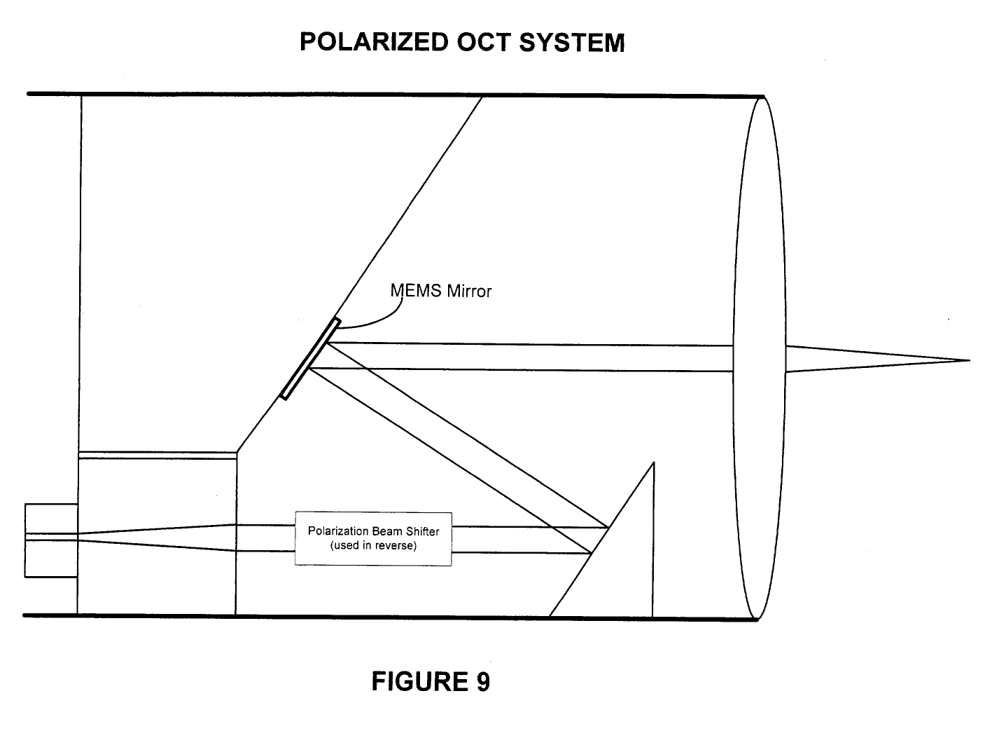

The present invention may also be used for Polarization OCT designed within an endoscope. For example, as seen in FIG. 9, a polarization beam splitter may be placed inside the endoscope before the first mirror, between where the fiber optics come in through the collimator and the first mirror which directs the light up to the MEMS mirror. The PBS, or polarization beam splitter or shifter, is used in the reverse way in which it is typically used. To use the beam splitter, a first collimated light signal (I1) comes into the PBS and a signal I2 comes out the other end. When the signal is reflected and goes back through the PBS, it is split into I1 and I3. These beams I1, I3 are cross polarized or orthogonally polarized. This PBS allows for the use of two small fibers to carry the light signal back to the imaging electronics.

Additionally and as briefly described with respect to the mirror actuation systems, because of the large beam size, the present invention can utilize two dimensional mirrors. If two of these mirrors are used together (one larger than the other), you can create a three dimensional image rather than a two dimensional image.

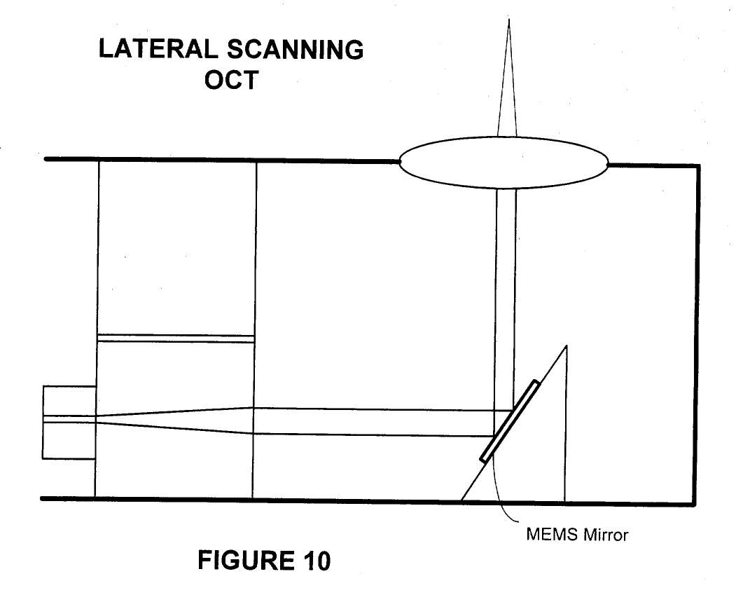

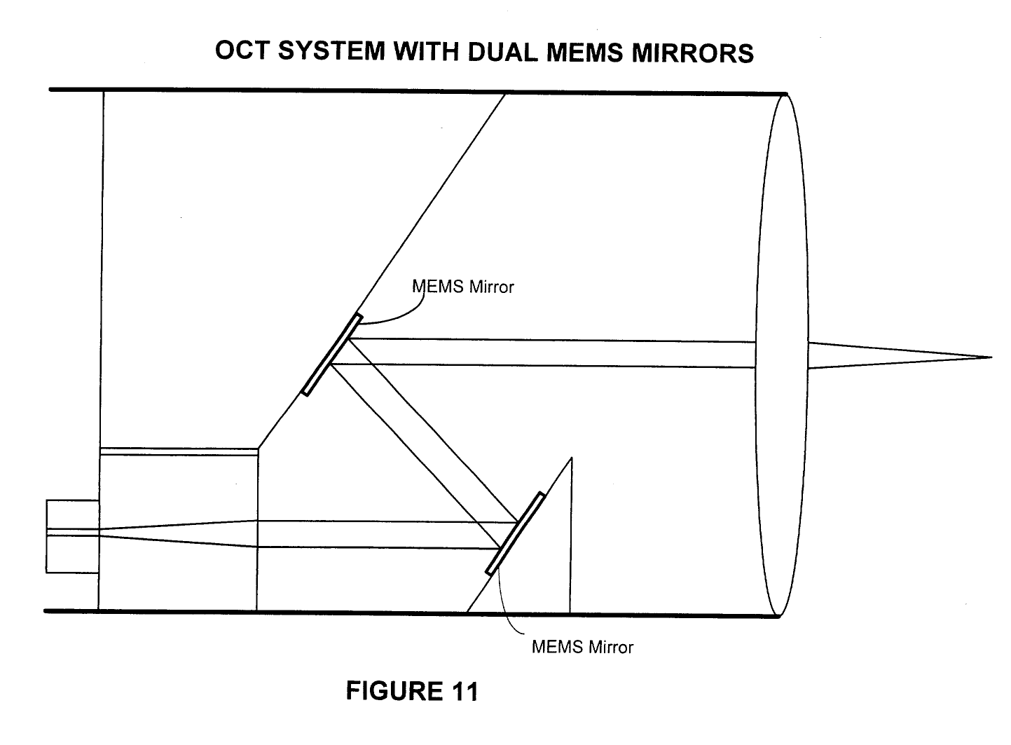

The mirrors may be oriented in different ways to achieve different effects. For example, as shown in FIG. 10, one MEMS mirror could be used to reflect light up and through a lens in a lateral scanning embodiment. Alternatively, a regular mirror could reflect the incoming light back and up into a MEMS mirror that sends the light out the front of the endoscopic (front view endoscopy FIGS. 1 and 2). If the first (regular) mirror is replaced with an additional MEMS mirror, then 3D scanning could be achieved (FIG. 11). One mirror would scan in the X-plane and the other could scan in the Y-plane. Any of the mirror control techniques could be used to impact motion to the mirror(s).

In an additional embodiment of the present invention, electro-optical deflector technology is used. The deflector preferably has electro-optical prism piles which, when an electrical signal is applied to those prism piles, the light will be deflected at various angles. This type of control is generally referred to as a “motionless lateral scan.” There are essentially no moving parts, no moving mirrors. Instead, electricity through a prism is used to deflect the light. The MEMS concept described above is on the border between moving and non-moving. This new electroprism embodiment is strictly non-moving.

As briefly stated above, the conventional rod lens system could also be replaced with additional imaging methodologies while also using the OCT with MEMS micromirrors. For example, the rod lens system could be replaced with a diagnostic fluoroscope that could be used for imaging the specimen while simultaneously viewing the internal structures via OCT. Many other embodiments and substitutions along these lines are also contemplated within the scope of this invention.

Nothing in the above description is meant to limit the present invention to any specific materials, geometry, or orientation of parts. Many part/orientation substitutions are contemplated within the scope of the present invention. The embodiments described herein were presented by way of example only and should not be used to limit the scope of the invention.

Although the invention has been described in terms of particular embodiments in an application, one of ordinary skill in the art, in light of the teachings herein, can generate additional embodiments and modifications without departing from the spirit of, or exceeding the scope of, the claimed invention. Accordingly, it is understood that the drawings and the descriptions herein are proffered by way of example only to facilitate comprehension of the invention and should not be construed to limit the scope thereof.

What is claimed is:

1. A laser scanning system, comprising:
an endoscope tube;
a broadband light source directed through said endoscope tube;
a MEMS micromirror that imparts a scan angle on said directed broadband light; and
a lens that focuses the broadband light onto a specimen.

2. The laser scanning system of claim 1, further comprising:
a second mirror adapted to reflect the directed broadband light up to the MEMS micromirror for front view laser scanning.

3. The laser scanning system of claim 2, wherein said second mirror is a second MEMS micromirror that is smaller than the first MEMS micromirror.

4. The laser scanning system of claim 1, wherein said MEMS micromirror is approximately ½ the width of the endoscope tube.

5. The laser scanning system of claim 1, further comprising:
a rod-lens based conventional imaging system in said endoscope tube for illumination and imaging the surface of a target object.

6. The laser scanning system of claim 1, wherein said MEMS micromirror is thermal-mechanically actuated.

7. The laser scanning system of claim 6, further comprising:
a bi-material cantilever that supports said MEMS micromirror.

8. The laser scanning system of claim 1, wherein said MEMS micromirror is electrostatically actuated.

9. The laser scanning system of claim 1, wherein said system utilizes optical coherence tomography (OCT).

10. The laser scanning system of claim 1, wherein said system utilizes confocal microscopy.

11. The laser scanning system of claim 1, wherein said system utilizes multi-photon endoscopy.

12. The laser scanning system of claim 1, further comprising prism piles.

13. The laser scanning system of claim 1, wherein said MEMS micromirror is approximately 1 millimeter by 1 millimeter across its face.

14. The laser scanning system of claim 1, wherein said MEMS micromirror includes an angle of deflection of approximately 14 degrees.

15. The laser scanning system of claim 5, wherein said rod lens system is offset by approximately 25 degrees such that the broadband light reflecting off the MEMS micromirror and the light from the rod lens system illuminate the same portion of the specimen.

16. The laser scanning system of claim 1, wherein said laser scanning methodology employs polarization optical coherence tomography.

17. A laser scanning system, comprising:
a broadband light source;
a fiber optic Michelson interferometer with a reference arm and a scanning arm attached to said broadband light source; and
an imaging assembly in the scanning arm of the interferometer which comprises a MEMS micromirror to impart a scan angle on said broadband light source.

18. The laser scanning system of claim 17, wherein the reference arm of the Michelson interferometer comprises an electro-optical phase shifter for imparting a Doppler shift on the broadband light.

19. The laser scanning system of claim 17, wherein said imaging assembly further comprises a polarization beam splitter.

20. A laser scanning system, comprising:
an 22Fr endoscope tube;
an OCT system inside said endoscope tube including a MEMS micromirror that imparts a scan angle on broadband light directed through said tube to said micromirror and a lens that focuses the broadband light onto a specimen; and
a fluoroscope inside said endoscope tube alongside said OCT system.
